(19) United States
(12) Patent Application Publication
(10) Pub. No.: US 2012/0243952 A1
(43) Pub. Date: Sep. 27, 2012

(54) ON LINE VIBRATION DETECTED AND INTELLIGENT CONTROL APPARATUS FOR CUTTING PROCESS WHICH INTEGRATED WITH MACHINE TOOL'S I/O MODULE AND METHOD THEREOF

(75) Inventors: Tzu-Hsin Kuo, Taipei County (TW); Chun-Hung Huang, Hsinchu County (TW); Tsang-Fang Jeng, Hsinchu City (TW); Dian-Yun Ji, Taichung City (TW)

(73) Assignee: INDUSTRIAL TECHNOLOGY RESEARCH INSTITUTE, Hsinchu (TW)

(21) Appl. No.: 13/112,857

(22) Filed: May 20, 2011

(30) Foreign Application Priority Data
Mar. 24, 2011 (TW) 100110038

(51) Int. Cl. B23B 35/00; B23B 41/00

(52) U.S. Cl. 408/1 R; 408/8

(57) ABSTRACT

An on-line vibration detected and intelligent control apparatus for cutting process which integrated with machine tool's I/O module and a method thereof are disclosed, which can detect vibration of the machine tool during a machining process and calculate a gain, which can be a plus value or a minus value, according to the detected vibration signal. By adding the gain to the current spindle speed or the current feed rate of the machining process, an updated spindle speed or an updated feed rate is obtained so as to be used in the machining process for compensating and thus preventing the vibration of the machine tool during the machining process.

### CROSS-REFERENCE TO RELATED APPLICATION

This non-provisional application claims priority under 35 U.S.C. §119(a) on Patent Application No. 100110038 filed in Taiwan, R.O.C. on Mar. 24, 2011, the entire contents of which are hereby incorporated by reference.

### TECHNICAL FIELD

The present disclosure relates to an on-line vibration detected and intelligent control apparatus for cutting process, designed to be integrated with an input/output (I/O) module of a machine tool, and the method thereof, by which the vibration of the machine tool during a machining process can be detected and used as base for updating and thus changing either the spindle speed or the feed rate of the machine tool so as to eliminate the vibration of the machine tool during the machining process, resulting that not only the wear and tear of the cutting tools used in the machining process can be reduced, but also the spindle accuracy of the machine tool can be maintained for achieving a better machining accuracy.

### TECHNICAL BACKGROUND

A machine tool is a powered mechanical device, typically used to fabricate metal components of machines by machining, which is the selective removal of metal.

Generally, machine tools can be divided into turning machines, drilling machines, milling machines and grinding machines, but no matter which type a machine tool is, it is primarily comprises: a frame; a workbench, mounted on the frame; at least one spindle, each disposed at a position above the workbench or proximate to the same while being configured with one blade holder that is provided for at least one cutting tool to mounted thereat; wherein the at least one cutting tool can be a milling cutter, a drilling bit, a reamer, or a boring cutter, that can be bring along to rotate in high speed or to move in a reciprocating manner for performing a machining process upon a workpiece.

Most times being unintended and undesirable that can result in imprecise processing and deteriorated surface qualities, machining vibration during the machining of any machine tool can be the most troubling problem that the machine tool industry tries to avoid. Vibration can result from a number of conditions, acting alone or in combination, such as inproper configuration in cutting parameters, dynamic unbalance in cutting tool assembly, chattering correspond to the relative movement between the workpiece and the cutting tool that can result in waves on the machined surface, thickness variation in workpiece that is to be machined, and resonance, etc. Since the effect of machining vibration can severe that, for instance, it can accelerate rates of wear in cutting tools, can cause the surface quality of a workpiece to deteriorate, and even cause deterioration in spindle accuracy, it is important for a machining center to be capable of preventing any machining vibration in an automatic manner during machining without inducing any adverse affect upon its machining efficiency.

Therefore, it is in need of an apparatus for preventing machining vibration of a machine tool.

### TECHNICAL SUMMARY

The present disclosure relates to an on-line vibration detected and intelligent control apparatus for cutting process, designed to be integrated with an input/output (IO) module of a machine tool, and the method thereof, by which the vibration of the machine tool during a machining process can be detected and used as base for updating and thus changing either the spindle speed or the feed rate of the machine tool so as to eliminate the vibration of the machine tool during the machining process, resulting that not only the wear and tear of the cutting tools used in the machining process can be reduced, but also the spindle accuracy of the machine tool can be maintained for achieving a better machining accuracy.

In a exemplary embodiment, the present invention provides an on-line vibration detected and intelligent control apparatus for cutting process, designed to be integrated with an input/output (I/O) module of a machine tool as the machine tool is comprised of: a workbench; a spindle, disposed at a position proximate to the workbench; and a controller, configured with an I/O module, the apparatus comprising: at least one vibration sensor, each disposed at a position selected from the group consisting of: the spindle and the workbench; a vibration signal processing unit, configured with a microcomputer processor and being electrically connected to the at least one vibration sensor and the I/O module.

In another exemplary embodiment, the present invention provides an intelligent control method for an on-line vibration detection apparatus that is integrated with an input/output (I/O) module of a machine tool, the method comprising the steps of:
detecting a vibration signal: detecting the vibration of a machine tool during a machining process while transmitting a vibration signal of the detection to a microcomputer processor embedded in a vibration signal processing unit;
calculating a gain: enabling the microcomputer processor to perform a calculation based upon the vibration signal for obtaining the standard deviation value relating to a vibration magnitude, and consequently, calculating a gain of spindle speed if the standard deviation value exceeds a threshold value;
detecting a current spindle speed that is currently in use by the machine tool: enabling the microcomputer processor to access a current spindle speed that is currently in use by the machine tool through an electronic I/O module and an I/O module of a controller;
obtaining an updated spindle speed: enabling the vibration signal processing unit to add the gain to the current spindle speed, despite that the gain can be a plus value or a minus value, and thus obtaining an updated spindle speed; and
enabling the updated spindle speed to replace the current spindle speed and to be used by the machine tool as its new current spindle speed: enabling the vibration signal processing unit to transmit the updated spindle speed to the controller through the I/O module for updating the current spindle speed into the updated spindle speed.

In further another exemplary embodiment, the present invention provides an intelligent control method for an on-line vibration detection apparatus that is integrated with an input/output (I/O) module of a machine tool, the method comprising the steps of:
detecting a vibration signal: detecting the vibration of a machine tool during a machining process while transmitting a vibration signal of the detection to a microcomputer processor embedded in a vibration signal processing unit;
calculating a gain: enabling the microcomputer processor to perform a calculation based upon the vibration signal for obtaining the standard deviation value relating to a vibration magnitude, and consequently, calculating a gain of feed rate if the standard deviation value exceeds a threshold value;
detecting a current feed rate that is currently in use by the machine tool: enabling the microcomputer processor to access a current feed rate that is currently in use by the machine tool through an electronic I/O module and an I/O module of a controller;
obtaining an updated feed rate: enabling the vibration signal processing unit to add the gain to the current feed rate, despite that the gain can be a plus value or a minus value, and thus obtaining an updated feed rate; and
enabling the updated feed rate to replace the current feed rate and to be used by the machine tool as its new current feed rate: enabling the vibration signal processing unit to transmit the updated feed rate to the controller through the I/O module for updating the current s feed rate into the updated feed rate.

By the aforesaid on-line vibration detected and intelligent control apparatus for cutting process, designed to be integrated with an input/output (I/O) module of a machine tool, and the method thereof, a vibration of a machine tool that is induced during a machining process will be detected by vibration sensors, and then the vibration sensors will send a vibration signal relating to the vibration to a microcomputer processor to be used as basis for calculating a gain of spindle speed or a gain of feed rate, and thus, based upon the gain, either the spindle speed or the feed rate of the machine tool is changed so as to eliminate the vibration of the machine tool during the machining process, resulting that not only the wear and tear of the cutting tools used in the machining process can be reduced, but also the spindle accuracy of the machine tool can be maintained for achieving a better machining accuracy.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing an on-line vibration detected and intelligent control apparatus for cutting process, designed to be integrated with an input/output (I/O) module of a machine tool according to an embodiment of the present disclosure.

FIG. 2 is a schematic diagram showing a controller, a vibration signal processing unit and a vibration sensor that are used in the present disclosure.

FIG. 3 is a flow chart depicting the steps performed in an intelligent control method for an on-line vibration detection apparatus that is integrated with an input/output (I/O) module of a machine tool according to the present disclosure.

FIG. 4 is a schematic diagram showing an on-line vibration detected and intelligent control apparatus for cutting process, designed to be integrated with an input/output (I/O) module of a machine tool according to another embodiment of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

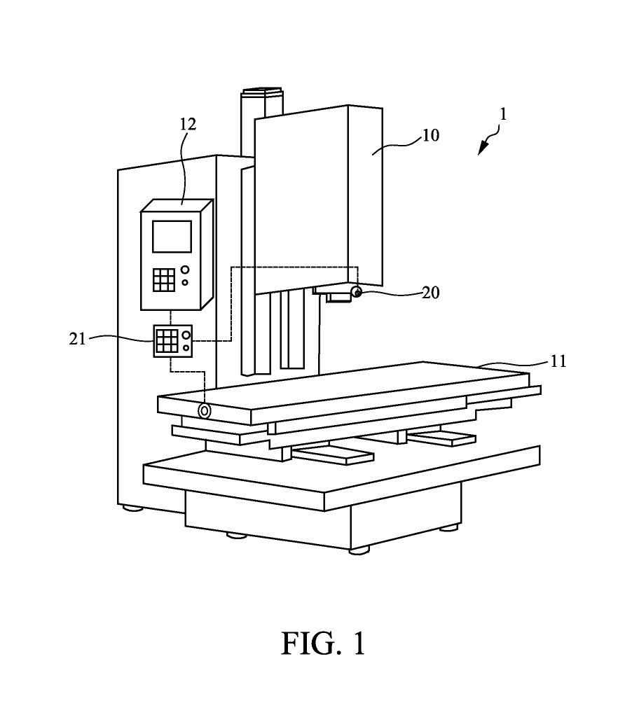

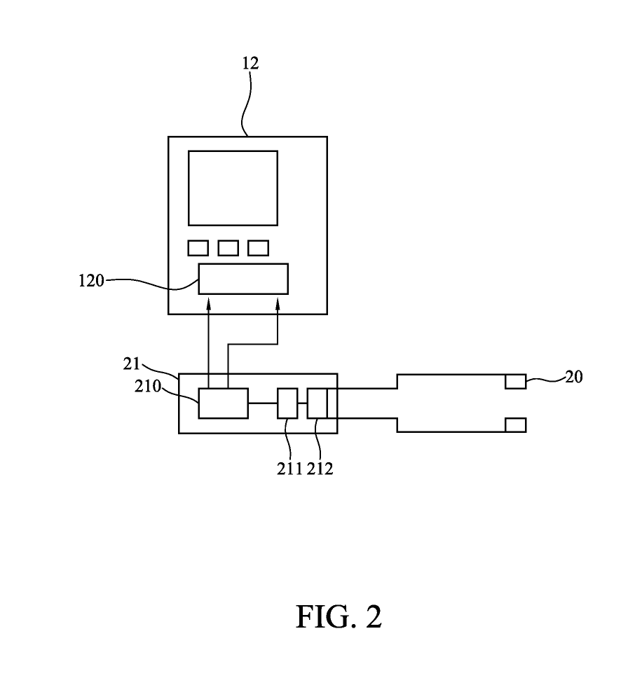

Please refer to FIG. 1 and FIG. 2, which are a schematic diagram showing an on-line vibration detected and intelligent control apparatus for cutting process, designed to be integrated with an input/output (I/O) module of a machine tool according to an embodiment of the present disclosure, and a schematic diagram showing a controller, a vibration signal processing unit and a vibration sensor that are used in the present disclosure. As shown in FIG. 1 and FIG. 2, the machine tool 1 comprises: a spindle 10, a workbench 11 and a controller 12, in which the spindle 10 is arranged at a position proximate to the workbench 11, and the controller 12 is further configured with an I/O module 120, which can substantially be a programmable logic control (PLC) I/O module. Moreover, the spindle 10 is further configured with a blade holder 100, and the controller 12 can be selectively mounted on the spindle 10.

In this embodiment, the on-line vibration detected and intelligent control apparatus comprises: at least one vibration sensor 20 and a vibration signal processing unit 21, in which each vibration sensor can be an MEMS sensor or an accelerometer, whereas the accelerometer is made of a quartz material.

In addition, the vibration signal processing unit 21 is further configured with an electronic I/O module 210, a microcomputer processor 211 and a band-pass filter 212 in a manner that the electronic I/O module 210, the microcomputer processor 211 and the band-pass filter 212 are electrically connected to each other. Moreover, the electronic I/O module 210 can be a solid-state electronic I/O module, the vibration signal processing unit 21 can be selectively mounted on the spindle 10, and the electronic I/O module 210 is electrically connected to the I/O module 120.

As shown in FIG. 1, the vibration sensor 20 is electrically connected to the band-pass filter 212, whereas the vibration sensor 20 can be disposed either at the spindle 10 or the workbench 11. It is noted that, for those vibration sensors that are mounted on the spindle 10, they are all being arranged at the blade holders 100 of the spindle 10.

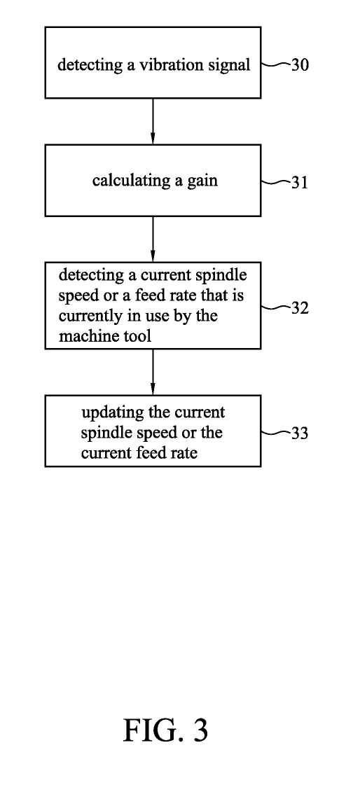

Please refer to FIG. 3, which is a flow chart depicting the steps performed in an intelligent control method for an on-line vibration detection apparatus that is integrated with an input/output (I/O) module of a machine tool according to the present disclosure. As shown in FIG. 3, the method of the present disclosure comprises the following steps:
detecting a vibration signal 30: enabling at least one vibration sensor 20 to detect the vibration of a machine tool 1, while transmitting the detected vibration signal to a band-pass filter 212 for noise filtering, and then the filtered vibration signal is then being transmitted by band-pass filter 212 to the microcomputer processor 211;
calculating a gain 31: enabling the microcomputer processor 211 to perform a calculation based upon the vibration signal for obtaining the standard deviation value relating to a vibration magnitude, and consequently, if the standard deviation value is not exceed a threshold value, the gain is set to be zero; and if the standard deviation value exceeds the threshold value, calculating a gain of spindle speed (ES) or a gain of feed rate (ES) using the following equations:

ES=KP*(EK−EK1)+KI*EK;

KP=(KPₘₐₓ−KPₘᵢₙ)*((10−abs(EK))/(10−STDAYV))+(KPₘₐₓ−KPₘᵢₙ)*((8−abs(EK−EK1))/8);

KI=(KIₘₐₓ−KIₘᵢₙ)*((abs(EK)−STDAYYV)/(10−STDAYV))+(KIₘₐₓ−KIₘᵢₙ)*((abs(EK−EK1)−0)/8);

wherein,
ES is the gain of spindle speed of the gain of feed rate;
KP and KI are parameters of adaptive control law;
EK is the standard deviation value obtained based upon the current detected vibration;
EK1 is the standard deviation value obtained based upon the vibration prior to the current detected vibration;
KPₘₐₓ, KPₘᵢₙ, KIₘₐₓ, KIₘᵢₙ are constants that relating to the material of the workpiece;
STDAYV is the standard average variation of the vibration signal.
detecting a current spindle speed that is currently in use by the machine tool 32: enabling the microcomputer processor 211 to access a current spindle speed of a current feed rate that is currently in use by the machine tool through the electronic I/O module 210 and an I/O module 120;
obtaining an updated spindle speed or updated feed rate 34: enabling the vibration signal processing unit 21 to add the gain to the current spindle speed or the current feed rate, despite that the gain can be a plus value or a minus value, and thus obtaining an updated spindle speed or an updated feed rate, i.e. the updated spindle speed=the current spindle speed+gain (ES), or the updated feed rate=the current feed rate+gain (ES); and
enabling the updated spindle speed or the updated feed rate to replace the current spindle speed or the current feed rate and to be used by the machine tool as its new current spindle speed or new current feed rate 34: enabling the vibration signal processing unit 21 to transmit the updated spindle speed or the updated feed rate to the controller 12 through the I/O module 120 for updating the current spindle speed or current feed rate into the updated spindle speed or the updated feed rate.

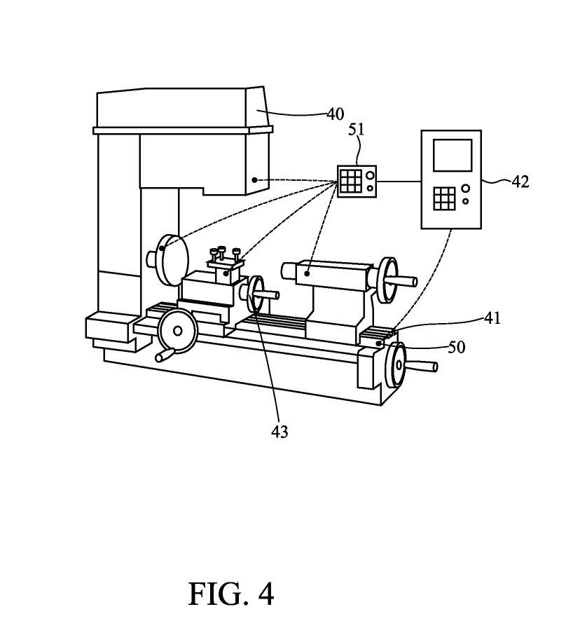

Please refer to FIG. 4, which is a schematic diagram showing an on-line vibration detected and intelligent control apparatus for cutting process, designed to be integrated with an input/output (I/O) module of a machine tool according to another embodiment of the present disclosure. As shown in FIG. 4, the machine tool 4 comprises: a spindle 40, a workbench 41 and a controller 42, in which the spindle 40 is arranged at a position proximate to the workbench 11, the workbench 41 is further configured with a workpiece holder 43, and the controller 42 can be selectively mounted on the spindle 40.

In this embodiment, the on-line vibration detected and intelligent control apparatus comprises: at least one vibration sensor 50 and a vibration signal processing unit 51. It is noted that the controller 42, the vibration sensor 50 and the vibration signal processing unit are basically the same as those disclosed in the prior embodiment, but at different locations. Thus, the description relating to the structures and functions of the controller 42, the vibration sensor 50 and the vibration signal processing unit 51 will not be described further hereinafter.

Moreover, the vibration sensor 50 can be selectively arranged at the spindle 40, the workbench 41 or the workpiece holder 43, and the vibration signal processing unit 51 is electrically connected to the controller 42 and the vibration sensor 50.

To sum up, the present disclosure provides an on-line vibration detected and intelligent control apparatus for cutting process, designed to be integrated with an input/output (I/O) module of a machine tool, which can detect vibration of the machine tool during a machining process by the use of vibration sensors that are selectively arranged at the spindle, the workbench, the blade holder or the workpiece holder, and then calculate a gain according to the detected vibration signal. Thereafter, by adding the gain to the current spindle speed or the current feed rate of the machine tool, an updated spindle speed or an updated feed rate is obtained so as to be used in the machining of the machine tool for compensating and thus preventing the vibration of the machine tool during the machining process, resulting that not only the wear and tear of the cutting tools used in the machining process can be reduced, but also the spindle accuracy of the machine tool can be maintained for achieving a better machining accuracy.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An on-line vibration detected and intelligent control apparatus for cutting process, designed to be integrated with an input/output (I/O) module of a machine tool as the machine tool is comprised of: a workbench; a spindle, disposed at a position proximate to the workbench; and a controller, configured with an I/O module, the apparatus comprising:
at least one vibration sensor, each disposed at a position selected from the group consisting of: the spindle and the workbench;
a vibration signal processing unit, configured with a microcomputer processor and being electrically connected to the at least one vibration sensor and the I/O module.

2. The apparatus of claim 1, wherein the vibration signal processing unit is further configured with an electronic I/O module and a band-pass filter in a manner that the electronic I/O module, the microcomputer processor and the band-pass filter are electrically connected to each other while the band-pass filter is further electrically connected to the at least one vibration sensor.

3. The apparatus of claim 2, wherein each vibration sensor is a device selected from the group consisting of: an MEMS sensor and an accelerometer.

4. The apparatus of claim 3, wherein the accelerometer is made of a quartz material.

5. The apparatus of claim 3, wherein the electronic I/O module is substantially a solid-state electronic I/O module.

6. The apparatus of claim 3, wherein the microcomputer processor is substantially a single-chip microcomputer processor.

7. The apparatus of claim 1, wherein the workbench is further configured with a workpiece holder, and the at least one vibration sensor is disposed at the workpiece holder.

8. The apparatus of claim 1, wherein the spindle is further configured with a blade holder, and the at least one vibration sensor is disposed at the blade holder.

9. The apparatus of claim 1, wherein the I/O module is substantially a programmable logic control (PLC) I/O module.

10. An intelligent control method for an on-line vibration detection apparatus that is integrated with an input/output (I/O) module of a machine tool, the method comprising the steps of:
detecting a vibration signal: detecting the vibration of a machine tool during a machining process while transmitting a vibration signal of the detection to a microcomputer processor embedded in a vibration signal processing unit;
calculating a gain: enabling the microcomputer processor to perform a calculation based upon the vibration signal for obtaining the standard deviation value relating to a vibration magnitude, and consequently, calculating a gain of spindle speed if the standard deviation value exceeds a threshold value;
detecting a current spindle speed that is currently in use by the machine tool: enabling the microcomputer processor to access a current spindle speed that is currently in use by the machine tool through an electronic I/O module and an I/O module of a controller;
obtaining an updated spindle speed: enabling the vibration signal processing unit to add the gain to the current spindle speed, despite that the gain can be a plus value or a minus value, and thus obtaining an updated spindle speed; and
enabling the updated spindle speed to replace the current spindle speed and to be used by the machine tool as its new current spindle speed: enabling the vibration signal processing unit to transmit the updated spindle speed to the controller through the I/O module for updating the current spindle speed into the updated spindle speed.

11. The method of claim 10, wherein in the step of vibration signal detection, the vibration of the machine tool is detected by the use of at least one vibration sensor, while the detected vibration signal is being transmitted to a band-pass filter for noise filtering, and then the filtered vibration signal is then being transmitted by band-pass filter to the microcomputer processor.

12. The method of claim 11, wherein in the step of gain calculation, the gain is set to be zero if the standard deviation value is not exceed the threshold value.

13. An intelligent control method for an on-line vibration detection apparatus that is integrated with an input/output (I/O) module of a machine tool, the method comprising the steps of:
detecting a vibration signal: detecting the vibration of a machine tool during a machining process while transmitting a vibration signal of the detection to a microcomputer processor embedded in a vibration signal processing unit;
calculating a gain: enabling the microcomputer processor to perform a calculation based upon the vibration signal for obtaining the standard deviation value relating to a vibration magnitude, and consequently, calculating a gain of feed rate if the standard deviation value exceeds a threshold value;
detecting a current feed rate that is currently in use by the machine tool: enabling the microcomputer processor to access a current feed rate that is currently in use by the machine tool through an electronic I/O module and an I/O module of a controller;
obtaining an updated feed rate: enabling the vibration signal processing unit to add the gain to the current feed rate, despite that the gain can be a plus value or a minus value, and thus obtaining an updated feed rate; and
enabling the updated feed rate to replace the current feed rate and to be used by the machine tool as its new current feed rate: enabling the vibration signal processing unit to transmit the updated feed rate to the controller through the I/O module for updating the current s feed rate into the updated feed rate.

14. The method of claim 13, wherein in the step of vibration signal detection, the vibration of the machine tool is detected by the use of at least one vibration sensor, while the detected vibration signal is being transmitted to a band-pass filter for noise filtering, and then the filtered vibration signal is then being transmitted by band-pass filter to the microcomputer processor.

15. The method of claim 14, wherein in the step of gain calculation, the gain is set to be zero if the standard deviation value is not exceed the threshold value.
